(19) United States
(12) Patent Application Publication
(10) Pub. No.: US 2026/0219633 A1
(43) Pub. Date: Jul. 30, 2026

(54) BOARD COOLING DEVICE AND IMAGE FORMING APPARATUS

(71) Applicant: KYOCERA Document Solutions Inc., Osaka (JP)

(72) Inventor: Kazuhiro Okamoto, Osaka (JP)

(21) Appl. No.: 19/457,519

(22) Filed: Jan. 23, 2026

(30) Foreign Application Priority Data
Jan. 27, 2025 (JP) 2025-011383

(51) Int. Cl. G03G 21/20; G03G 15/00; G03G 21/16

(52) U.S. Cl. CPC G03G 21/206; G03G 15/80; G03G 21/1619; G03G 2221/1639; G03G 2221/1645

(57) ABSTRACT

A board cooling device includes a board, a casing, one or more fans, and a first air channel. On the board, one or more components are mounted. The casing houses the board. The one or more fans form an airflow into the casing from a specific space in which a process unit that performs processing associated with heat generation in an apparatus main body of an image forming apparatus is disposed.

### INCORPORATION BY REFERENCE

This application is based upon and claims the benefit of priority from the corresponding Japanese Patent Application No. 2025-011383 filed on January 27, 2025, the entire contents of which are incorporated herein by reference.

The present disclosure relates to a board cooling device and an image forming apparatus.

### BACKGROUND

A board cooling method in an image forming apparatus is known as a related art. In this board cooling method, a recording material is conveyed to a predetermined image forming region while causing the recording material to closely adhere to an endless perforated conveyor belt by suction of a suction duct through the belt. In this board cooling method, exhaust air from the suction duct is sent to a shield box installed inside the image forming apparatus to cool a board housed in the box.

### SUMMARY

A board cooling device according to an aspect of the present disclosure includes a board, a casing, and one or more fans. On the board, one or more components are mounted. The casing houses the board. The one or more fans form an airflow into the casing from a specific space in which a process unit that performs processing associated with heat generation in an apparatus main body of an image forming apparatus is disposed.

An image forming apparatus according to another aspect of the present disclosure includes: an apparatus main body; a process unit that is disposed in the apparatus main body and performs processing associated with heat generation; and the board cooling device described above.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF FIGURES

FIG. 1 is a schematic diagram showing a configuration of an image forming apparatus including a board cooling device according to an embodiment.

FIG. 2 is a schematic diagram showing a configuration of a first air channel in the board cooling device according to the embodiment.

FIG. 3 is a schematic diagram showing an operation example of the board cooling device according to the embodiment.

### DETAILED DESCRIPTION

Hereinafter, an embodiment of the present disclosure will be described with reference to the accompanying drawings. The following embodiment is an example embodying the present disclosure and is not intended to limit the technical scope of the present disclosure.

### 1 Overall Configuration of Image Forming Apparatus

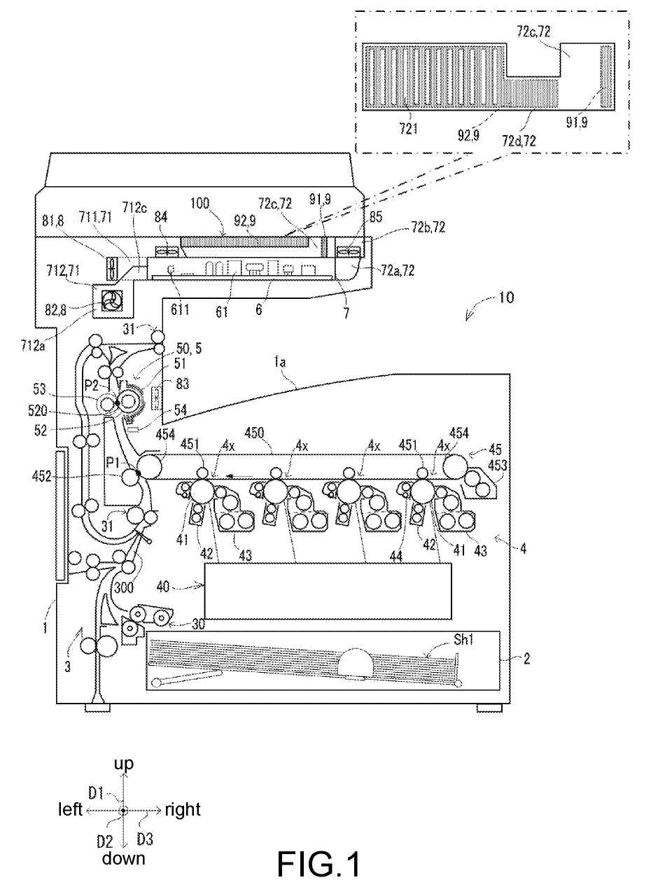

First, an overall configuration of an image forming apparatus 10 according to this embodiment will be described with reference to FIG. 1. In the following, for the sake of description, a vertical direction in an installation state in which the image forming apparatus 10 can be used (state shown in FIG. 1) is defined as an up-down direction D1. In addition, a direction orthogonal to the plane showing the image forming apparatus 10 in FIG. 1 is defined as a front-back direction D2, and a surface on the near side in FIG. 1 is defined as a back surface (rear surface). Further, a left-right direction D3 is defined with a surface on the left side on the plane of FIG. 1 being defined as a left-side surface. Note that the definitions of the above directions are not intended to limit the mode of use of the image forming apparatus 10.

The image forming apparatus 10 according to this embodiment performs print processing by an electrophotographic method. In this case, the print processing is processing of forming an image on a sheet Sh1. As shown in FIG. 1, the image forming apparatus 10 includes a sheet housing portion 2, a sheet conveying device 3, and a printing device 4. The sheet conveying device 3 and the printing device 4 are housed in an apparatus main body 1. The apparatus main body 1 includes a main body frame that forms the framework of the apparatus main body 1, and an exterior member attached to the main body frame.

The sheet conveying device 3 includes a sheet feeder 30 and a plurality of conveyance roller pairs 31. The sheet feeder 30 feeds the sheets Sh1 located in the sheet housing portion 2 one by one to a conveyance path 300. The conveyance path 300 is a passage for the sheets Sh1.

The plurality of conveyance roller pairs 31 convey the sheets Sh1 along the conveyance path 300. One pair of the plurality of conveyance roller pairs 31 discharges the sheet Sh1 on which an image has been formed from the conveyance path 300 to a discharge tray 1a.

The printing device 4 performs print processing on the sheet Sh1 conveyed along the conveyance path 300. The image formed on the sheet Sh1 is a toner image. The printing device 4 includes an optical scanning unit 40, one or more (in this embodiment, four) image forming sections 4x, a transfer device 45, and a fuser 50. Each image forming section 4x includes a photoreceptor 41, a charging device 42, a developing device 43, and a drum cleaner 44.

The charging device 42 electrically charges the surface of the photoreceptor 41. The optical scanning unit 40 scans the surface of the charged photoreceptor 41 with a beam of light. Thus, the optical scanning unit 40 forms an electrostatic latent image on the surface of the photoreceptor 41.

The developing device 43 develops the electrostatic latent image to obtain a toner image by supplying toner to the surface of the photoreceptor 41. The transfer device 45 transfers the toner image formed on the surface of the photoreceptor 41 to the sheet Sh1.

The transfer device 45 transfers the toner image formed on the photoreceptor 41 to the sheet Sh1. The transfer device 45 transfers the toner image to the sheet Sh1 at a transfer position P1 in the conveyance path 300. The photoreceptor 41 is an example of an image carrier that rotates while carrying the toner image.

In this embodiment, the printing device 4 is a tandem-type color printing device including a plurality of image forming sections 4x. In addition, the transfer device 45 includes an intermediate transfer belt 450, a plurality of primary transfer devices 451, a secondary transfer device 452, a belt cleaner 453, and a plurality of support rollers 454.

In the example shown in FIG. 1, the printing device 4 includes four image forming sections 4x respectively corresponding to four colors of toner, yellow, magenta, cyan, and black. The transfer device 45 includes four primary transfer devices 451 respectively corresponding to the four image forming sections 4x.

The intermediate transfer belt 450 is rotatably supported by the plurality of support rollers 454. One of the plurality of support rollers 454 rotates when driven by a belt drive device (not shown). Thus, the intermediate transfer belt 450 rotates.

Each of the primary transfer devices 451 transfers the toner image, which has been formed on the surface of the photoreceptor 41 in the corresponding image forming section 4x, to the surface of the intermediate transfer belt 450. As a result, a toner image that is a composite of the toner images of the four colors is formed on the surface of the intermediate transfer belt 450.

The intermediate transfer belt 450 rotates while carrying the toner image. The secondary transfer device 452 transfers the toner image, which has been formed on the surface of the intermediate transfer belt 450, to the sheet Sh1 at the transfer position P1.

The drum cleaner 44 removes primary waste toner from the surface of the photoreceptor 41. Here, the primary waste toner is the toner remaining on a portion, of the surface of the photoreceptor 41, which has passed through the primary transfer device 451.

The belt cleaner 453 removes secondary waste toner from the surface of the intermediate transfer belt 450. Here, the secondary waste toner is the toner remaining on a portion, of the surface of the intermediate transfer belt 450, which has passed through the secondary transfer device 452.

The fuser 50 heats and pressurizes the toner image on the sheet Sh1 at a fusing position P2 in the conveyance path 300. Thus, the fuser 50 fuses the toner image on the sheet Sh1. The fusing position P2 is a position located downstream of the transfer position P1 in the sheet conveyance direction.

As shown in FIG. 1, the fuser 50 includes a heater 5, a fusing belt 52, a fusing roller 520, a pressure roller 53, and a temperature sensor 54.

The fusing belt 52 is a flexible cylindrical member that encloses the fusing roller 520. The fusing belt 52 is heated by the heater 51. The fusing roller 520 is a cylindrical member that supports the fusing belt 52 on the inside thereof. The fusing roller 520 is rotatably supported. The fusing belt 52 can rotate together with the fusing roller 520. The fusing belt 52 includes a conductive base material, an elastic layer formed on the outer circumference of the base material, and a release layer formed on the outer circumference of the elastic layer.

The heater 51 is disposed opposite the outer circumferential surface of the fusing belt 52 to heat the fusing belt 52. In this embodiment, the heater 51 is a heating device of an electromagnetic induction heating type. The heater 51 mainly heats the base material of the fusing belt 52 by electromagnetic induction. Note that the heater 51 is not limited to the heating device of an electromagnetic induction heating type, but may be a halogen heater, for example.

The pressure roller 53 is rotatably supported. The pressure roller 53 is driven by a drive device (not shown) to rotate. The fusing belt 52 and the fusing roller 520 both rotate in conjunction with the pressure roller 53. The fusing belt 52, which is heated by the heater 51, heats the toner image formed on the sheet Sh1. The pressure roller 53 biases the sheet Sh1 to the fusing belt 52 to pressurize the toner image toward the sheet Sh1.

The temperature sensor 54 is a sensor that detects a temperature of the surface of the fuser 50, especially the fusing belt 52. The detection result of the temperature sensor 54 is used to control the temperature of the surface of the fusing belt 52 to a predetermined range. In this embodiment, the temperature sensor 54 is a non-contact temperature sensor, such as a thermopile, and is disposed at a distance from the fusing belt 52.

By the way, a board cooling method in an image forming apparatus is known as a related art for this type of image forming apparatus. In this board cooling method, a recording material is conveyed to a predetermined image forming region while causing the recording material to closely adhere to an endless perforated conveyor belt by suction of a suction duct through the belt. In this board cooling method, exhaust air from the suction duct is sent to a shield box installed inside the image forming apparatus to cool a board housed in the box.

Here, the image forming apparatus includes an process unit that performs processing associated with heat generation, such as a fusing device that performs fusing processing of heating a toner image on a sheet to fuse the toner image onto the sheet. The above related art can cool the board by exhaust air from the suction duct, but fails to suppress the occurrence of failures caused by water vapor that is generated in the above processing of the process unit and stays near the process unit, which is problematic.

Specifically, if the process unit is a fusing device, the fusing device generates heat during the fusing processing. This heat generation evaporates the moisture contained in the sheet to which the fusing processing is performed, generating water vapor. If the water vapor stays near the process unit and adheres to a rib provided on the sheet conveyance path, a failure may occur in which streaks due to condensation occur on the sheet that has come into contact with the rib. In addition, if water vapor stays near the process unit and exists between a fusing belt of the fusing device and a temperature sensor, a failure may occur in which the temperature detection by the temperature sensor is prone to errors, and the accuracy of controlling the temperature of the surface of the fusing belt is reduced.

In contrast, in this embodiment, the configuration to be described below makes it possible to achieve a board cooling device 100 and the image forming apparatus 10 that are capable of cooling the board while suppressing the occurrence of failures caused by water vapor generated by processing associated with heat generation in the process unit.

Specifically, the image forming apparatus 10 includes the apparatus main body 1, the process unit 5 that is disposed in the apparatus main body 1 and performs processing associated with heat generation, and a board cooling device 100 to be described later. In this embodiment, the process unit 5 is the fuser 50 that performs the fusing processing of heating a toner image on a sheet Sh1 to fuse the toner image onto the sheet Sh1.

As shown in FIG. 1, the board cooling device 100 includes a board 6, a casing 7, one or more fans 8 (in this embodiment, including a pair of first fans 81 and a second fan 82), a first air channel 71, a second air channel 72, and a filter 9. In addition, the board cooling device 100 further includes a third fan 83, a fourth fan 84, and a fifth fan 85.

The one or more components 61 are mounted on the board 6. Specifically, a control circuit is mounted on the board 6. The control circuit controls one or more of a plurality of devices included in the image forming apparatus 10, such as the sheet conveying device 3, the printing device 4, and the fuser 50. The one or more components 61 constituting the control circuit are mounted on the board 6. Note that a control circuit of the process unit 5 may not be mounted on the board 6.

In this embodiment, the board 6 is a control board of the heater 51 included in the fuser 50. Specifically, mounted on the board 6 is a control circuit that controls the heater 51 including an electromagnet, which is a heating device of an electromagnetic induction heating type. The one or more components 61 constituting the control circuit are mounted on the board 6. In other words, the one or more components 61 include components for controlling the heater 51 included in the fuser 50.

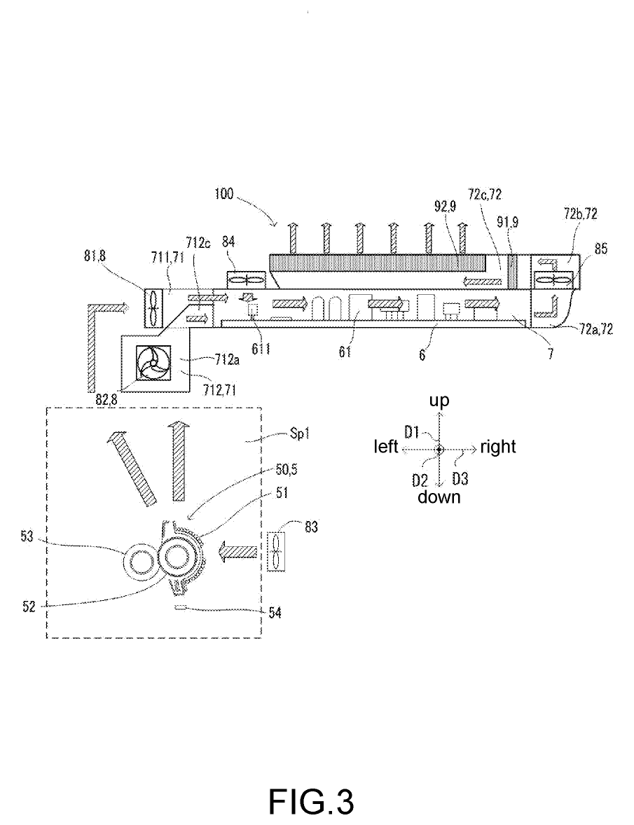

Here, since the control circuit of the heater 51 supplies a relatively large amount of power to the heater 51 to heat the fusing belt 52, the amount of heat generated on the board 6 is relatively large. In this embodiment, as will be described later, the one or more fans 8 cool the board 6 by blowing air, which is suctioned from a specific space Spb (see FIG. 3) in which the fuser 50 is disposed, toward the board 6. This has the advantage that not only the fuser 50 but also the control circuit of the heater 51 can be cooled by the one or more common fans 8 in this embodiment, thus eliminating the need to provide separate fans for the fuser 50 and the control circuit of the heater 51.

The casing 7 houses the board 6. Specifically, the casing 7 has a rectangular parallelepiped shape that is long in the left-right direction D3, and houses the board 6 with the mounting surface on which the one or more components 61 are mounted facing up. In this embodiment, the casing 7 is a shield box that blocks radio waves from inside and outside. In addition, in this embodiment, the casing 7 is disposed at the upper portion of the apparatus main body 1 and above the discharge tray 1a.

Note that the casing 7 may be disposed in other positions, not limited to the upper portion of the apparatus main body 1. In other words, the casing 7 only needs to be disposed at a position at which air that has passed through the filter 9 to be described later, including the first air channel 71 and the second air channel 72 to be described later, can escape to an external space of the image forming apparatus 10 (i.e., the atmosphere).

The one or more fans 8 form the airflow from the specific space Sp1 into the casing 7. Here, the specific space Sp1 is a space in which the process unit 5 that performs processing associated with heat generation in the apparatus main body 1 of the image forming apparatus 10 is disposed. In this embodiment, the specific space Sp1 is a space in which the fuser 50 that is the process unit 5 is disposed. Each fan 8 is an axial-flow fan including a blade at the center, and suctions air from an intake surface, which is one surface of the blade in the axial direction, and blows out the suctioned air from an exhaust surface, which is the other surface of the blade in the axial direction.

In this embodiment, the one or more fans 8 are disposed at positions where air is suctioned from the specific space Sp1. Specifically, each fan 8 is disposed with its intake surface facing the specific space Sp1 or the space connected to the specific space Sp1. This makes it possible for the one or more fans 8 to form an airflow from the specific space Sp1 to the casing 7 by suctioning air from the specific space Sp1.

In this embodiment, the one or more fans 8 include a pair of first fans 81 and a second fan 82. Note that FIG. 1 shows only a single first fan 81 disposed at the rear in the pair of first fans 81.

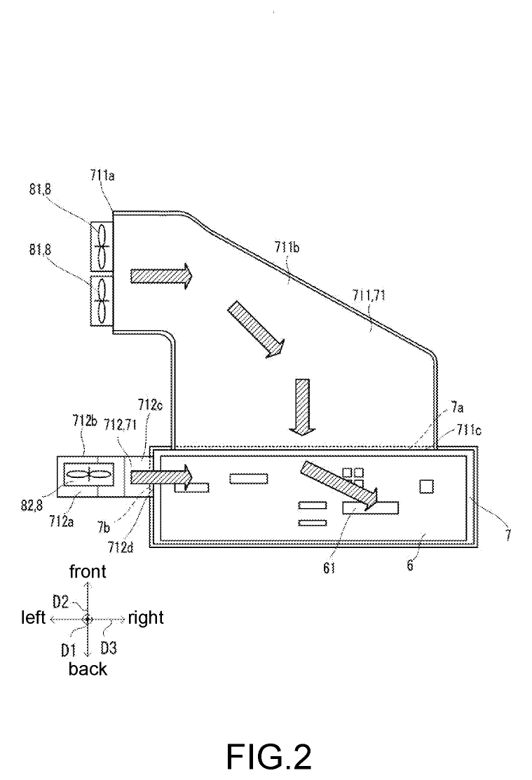

The pair of first fans 81 are disposed at the upper portion of the apparatus main body 1 and in front of the casing 7. The pair of first fans 81 are disposed side by side in the front-back direction D2 as shown in FIG. 2, and are each disposed such that the intake surface faces leftward and the exhaust surface faces rightward. The space on the left of the pair of first fans 81 is connected to the specific space Sp1. Therefore, as shown in FIG. 3, the pair of first fans 81 can suction air of the specific space Sp1 from the intake surfaces and blow out the suctioned air from the exhaust surfaces rightward when the pair of first fans 81 are driven.

The second fan 82 is disposed at the upper portion of the apparatus main body 1 and in the lower left of the casing 7. The second fan 82 is disposed such that the intake surface faces forward and the exhaust surface faces backward. The space in front of the second fan 82 is connected to the specific space Sp1. Therefore, as shown in FIG. 3, the second fan 82 can suction air of the specific space Sp1 from the intake surface and blow out the suctioned air from the exhaust surface backward when the second fan 82 is driven.

The first air channel 71 is an air channel that guides the air blown out from the one or more fans 8 into the casing 7. Specifically, the first air channel 71 is a hollow member through which the air blown out from the exhaust surface of each fan 8 passes, and has an opening on a surface. The surface including the opening of the first air channel 71 is mechanically connected to any corresponding surface of the casing 7. In addition, the above opening is connected to an opening provided to the corresponding surface of the casing 7. Therefore, the air blown out from each fan 8 is guided into the casing 7 through the first air channel 71 and those openings.

In this embodiment, as shown in FIGS. 1 and 2, the first air channel 71 includes a first guideway 711 and a second guideway 712. The first guideway 711 is an air channel that guides the air blown out from the pair of first fans 81 into the casing 7 through a first opening 7a of the surface (in this case, front surface) of the casing 7. The second guideway 712 is an air channel that guides the air blown out from the second fan 82 into the casing 7 through a second opening 7b of another surface (in this case, left surface) of the casing 7. This has the advantage that the air blown out from each of the first fan 81 and the second fan 82 can be merged within the casing 7, making it easy to cool the board 6 more efficiently than the case where only one of the first fan 81 and the second fan 82 is used.

Specifically, as shown in FIG. 2, the first guideway 711 is formed of a flat duct having a thickness equivalent to the height dimension of the pair of first fans 81 in the up-down direction D1. One end (in this case, left end) close to the pair of first fans 81 in the first guideway 711 is provided with an opening 711a through which the air blown out from the exhaust surfaces of the pair of first fans 81 passes. The dimension of the opening 711a in the width direction (in this case, front-back direction D2) is, for example, about twice the dimension of the pair of first fans 81 in the width direction.

In addition, one end (in this case, back end) close to the casing 7 in the first guideway 711 is provided with an opening 711c through which the air passing through the first guideway 711 passes. The dimension of the opening 711c in the width direction (in this case, left-right direction D3) is, for example, nearly equal to the dimension of the casing 7 in the length direction. In addition, the portion between those openings 711a and 711c in the first guideway 711 is a passage 711b that changes the direction of the air blown out rightward from the pair of first fans 81 to the backward direction by causing the air to collide with an inner wall (in this case, the right wall in the first guideway 711). Note that the inner wall is inclined such that the momentum of the air that has collided is not weakened more than necessary, in other words, the air is blown out into the casing 7 with sufficient momentum to cool the board 6.

Therefore, as shown in FIG. 2, the air blown out rightward from the pair of first fans 81 passes through the passage 711b via the opening 711a and colliding with the inner wall, to thereby flow backward. The air blown out backward from the passage 711b is then guided into the casing 7 through the opening 711c and the first opening 7a of the casing 7.

As shown in FIGS. 1 and 2, the second guideway 712 includes a case 712a and a duct 712c. The case 712a has a rectangular parallelepiped shape having a thickness larger than the dimension of the second fan 82 in the front-back direction D2, and houses the second fan 82 therein. In addition, a surface of the case 712a (in this case, front surface), opposite the intake surface of the second fan 82, is provided with an opening 712b that allow air to pass from the outside of the case 712a to the inside of the case 712a. The area of the opening 712b is, for example, nearly equal to the area of the intake surface of the second fan 82.

One end (in this case, lower end) of the duct 712c is connected to the upper end of the case 712a, and an opening 712d provided at another end (in this case, right end) of the duct 712c is connected to the second opening 7b of the casing 7. In addition, the portion between the one end and the other end of the duct 712c is configured to change the direction of the air blown out upward from the case 712a to the rightward direction by causing the air to collide with an inner wall (in this case, the upper wall in the duct 712c). Note that the inner wall is inclined such that the momentum of the air that has collided is not weakened more than necessary, in other words, the air is blown out into the casing 7 with sufficient momentum to cool the board 6.

Therefore, as shown in FIGS. 1 and 2, the air blown out backward from the second fan 82 passes through the duct 712c while colliding with the inner wall of the case 712a, and flows rightward by colliding with the inner wall of the duct 712c. The air blown out rightward from the duct 712c is then guided into the casing 7 through the second opening 7b of the casing 7.

The second air channel 72 is an air channel that includes, on one surface (in this case, the upper surface), one or more ventilation holes 721 connected to the external space of the image forming apparatus 10, and guides air from the inside of the casing 7 to the one or more ventilation holes 721. Specifically, the second air channel 72 is a hollow member through which the air blown out from the casing 7 passes, and has an opening on a surface. The second air channel 72 is mechanically connected to any corresponding surface of the casing 7 through the surface including the opening. In addition, the above opening is connected to an opening provided to the corresponding surface of the casing 7. Therefore, the air passing through the casing 7 passes through the second air channel 72 via those openings and is exhausted to the external space via the one or more ventilation holes 721.

Specifically, as shown in FIG. 1, the second air channel 72 includes a first passage 72a, a second passage 72b, and a third passage 72c.

One end (in this case, left end) of the first passage 72a is connected to one surface (in this case, right surface) of the casing 7, and another end (in this case, upper end) of the first passage 72a is connected to the second passage 72b located above the first passage 72a. In addition, the portion between the one end and the other end of the first passage 72a is configured to change the direction of the air blown out rightward from the casing 7 to the upward direction by causing the air to collide with an inner wall (in this case, the right wall in the first passage 72a). Note that the inner wall is inclined such that the momentum of the air that has collided is not weakened more than necessary, in other words, the air is blown out upward with sufficient momentum enough to reach the second passage 72b.

One end (in this case, lower end) of the second passage 72b is connected to the first passage 72a, and another end (in this case, left end) of the second passage 72b is connected to the third passage 72c located on the left of the second passage 72b. A fifth fan 85 to be described later is disposed at the bottom portion of the second passage 72b. In addition, the portion between the one end and the other end of the second passage 72b is configured to change the direction of the air blown out upward from the first passage 72a to the leftward direction by causing the air to collide with an inner wall (in this case, the upper wall in the second passage 72b). Note that the surface of the inner wall is substantially parallel to the exhaust surface of the fifth fan 85. Therefore, the momentum of the air that has reached the second passage 72b is weakened by collision with the inner wall when passing through the second passage 72b.

The third passage 72c has a rectangular parallelepiped shape that is long in the left-right direction D3, and houses the filter 9 (first filter 91 and second filter 92 to be described later) therein. One end (in this case, right end) of the third passage 72c is connected to the second passage 72b. In addition, the plurality of ventilation holes 721 are provided to a wall (in this case, the upper wall) in the third passage 72c, opposite the external space of the image forming apparatus 10. The plurality of ventilation holes 721 are long slits in the front-back direction D2 and are provided to the upper wall of the third passage 72c at intervals along the left-right direction D3. The air within the third passage 72c is exhausted to the external space of the image forming apparatus 10 via those ventilation holes 721.

A narrow passage 72d is provided in the middle portion of the third passage 72c in the left-right direction D3. The dimension of the narrow passage 72d in the width direction (in this case, front-back direction D2) is smaller than the dimension in the width direction of a portion, other than the narrow passage 72d, of the third passage 72c. Therefore, the momentum of the air that has reached the third passage 72c is weakened when passing through the narrow passage 72d.

The third fan 83 is a fan that blows out air toward the process unit 5 (in this case, fuser 50). Specifically, the third fan 83 is an axial-flow fan, similar to the first fan 81 and the second fan 82. The third fan 83 is disposed with its intake surface facing the external space of the image forming apparatus 10 and its exhaust surface facing the process unit 5. This has the advantage that the air blown out from the third fan 83 can disperse water vapor generated by the processing associated with heat generation (in this case, fusing processing) of the process unit 5, thus making it easier to suppress the occurrence of failures caused by the water vapor. In addition, another advantage is that the air blown out from the third fan 83 can cool the process unit 5 such that the process unit 5 does not become excessively hot.

In this embodiment, the third fan 83 is a pair of fans disposed side by side in the front-back direction D2. Note that FIG. 1 shows only a single third fan 83 disposed backward in the pair of third fans 83.

Specifically, the dispersion of water vapor prevents water vapor from adhering to the ribs provided to the conveyance path for the sheet Sh1 and prevents streaks caused by condensation from occurring on the sheet Sh1. In addition, the dispersion of water vapor makes it difficult for water vapor to intervene between the fusing belt 52 of the fuser 50 and the temperature sensor 54, thus making it difficult to cause errors in the detection of the temperature by the temperature sensor 54.

The fourth fan 84 is a fan that blows out air toward a specific component 611, which generates more heat than the other components among the one or more components 61 mounted on the board 6. The specific component 611 can include, for example, a condenser. Specifically, the fourth fan 84 is an axial-flow fan, similar to the first fan 81 and the second fan 82. The fourth fan 84 is disposed on one surface (in this case, the upper surface) of the casing 7 with its intake surface facing the external space of the image forming apparatus 10 and its exhaust surface facing the specific component 611 in the casing 7 through an opening provided to the one surface. This has the advantage that the air blown out from the fourth fan 84 makes it easier to cool the specific component 611, which generates a relatively large amount of heat in the board 6, as compared to the case without the fourth fan 84.

The fifth fan 85 is a fan that suctions the air blown out from the casing 7 and blows out the suctioned air toward a portion of the second air channel 72, in which the filter 9 is disposed (in this case, third passage 72c). Specifically, the fifth fan 85 is an axial-flow fan, similar to the first fan 81 and the second fan 82. The fifth fan 85 is disposed with its intake surface facing an opening provided at the upper end of the first passage 72a and its exhaust surface facing the upper wall of the second passage 72b, in the second passage 72b of the second air channel 72. This has the advantage that the air blown out from the casing 7 more easily reaches the portion of the second air channel 72, in which the filter 9 is disposed, as compared to the case without the fifth fan 85.

The filter 9 is disposed inside at least one of the casing 7, the first air channel 71, or the second air channel 72 to separate and collect foreign matter contained in the air. This has the advantage that the air is exhausted to the external space of the image forming apparatus 10 via the one or more ventilation holes 721 while the foreign matter contained in the air is removed by the filter 9, so that the atmosphere is less likely to be contaminated.

Here, the foreign matter is atmospheric pollutant that is generated inside the image forming apparatus 10 and is undesirable to flow to the external space of the image forming apparatus 10 (i.e., the atmosphere). For example, the foreign matter may include gas such as nitrogen oxide (NOx) or ozone. In addition, for example, the foreign matter can include fine particles such as dust, volatile organic compounds (VOCs), or ultrafine particles (UFPs). The foreign matter is generated, for example, when part of resin such as silicone resin evaporates due to heat generated by the process unit 5. Therefore, the source of generation of foreign matter is not limited to the components constituting the process unit 5, but also includes components such as conveyance rollers in the vicinity of the process unit 5.

In this embodiment, the filter 9 is disposed in the second air channel 72. Specifically, the filter 9 includes the first filter 91 and the second filter 92. Both the first filter 91 and the second filter 92 are disposed in the third passage 72c of the second air channel 72.

The first filter 91 is a filter that separates and collects foreign matter, mainly including VOCs, from the air, and is, for example, an activated carbon filter. The first filter 91 is disposed opposite an opening at the right end, which corresponds to an air inlet in the third passage 72c. The area of the first filter 91 viewed from the left-right direction D3 is nearly equal to, for example, the area of the opening at the right end of the third passage 72c. As a result, the air is guided into the third passage 72c with the foreign matter mainly including VOCs in the air being removed by the first filter 91.

The second filter 92 is a filter that separates and collects foreign matter, mainly including UFPs, from the air, and is, for example, an activated carbon filter. The second filter 92 is disposed opposite the upper end corresponding to an air outlet in the third passage 72c, more specifically, the upper wall provided with the one or more ventilation holes 721. The area of the second filter 92 viewed from the up-down direction D1 is nearly equal to, for example, the area of the upper wall of the third passage 72c. As a result, the air is exhausted to the external space of the image forming apparatus 10 via the one or more ventilation holes 721 with foreign matter mainly including UFPs in the air being removed by the second filter 92. Note that, for example, foreign matter other than VOCs and UFPs, such as NOx, dust, or ozone are also removed by at least one of the first filter 91 or the second filter 92.

Here, a filtration air velocity is important for efficient separation and collection of foreign matter in the filter 9. The filtration air velocity is an average air velocity of gas (in this case, air) passing through the filter 9. Basically, as the filtration air velocity becomes lower, a dust collection rate becomes higher, that is, it becomes easier to separate and collect foreign matter, but if the filtration air velocity is too low, the time required for filtration becomes longer. Hence, it is important to set the filtration air velocity to be appropriate for the separation and collection of foreign matter. For example, the filtration air velocity appropriate for the filter 9 is less than 1 m/s, but the air velocity of the air blown out by the fifth fan 85 is 10 m/s, for example. Therefore, it is undesirable to guide the air blown out by the fifth fan 85 directly to the filter 9.

In this regard, in this embodiment, the second air channel 72 includes one or more restriction paths that restrict the flow of air guided to the filter 9. Specifically, the second passage 72b of the second air channel 72 and the narrow passage 72d of the second air channel 72 correspond to the one or more restriction paths. This has the advantage that the air velocity of the air passing through the filter 9 can be reduced to a filtration air velocity appropriate for the filter 9 by weakening the momentum of the air in the one or more restriction paths, thereby facilitating efficient separation and collection of foreign matter in the filter 9.

### 2 Operation Example of Board Cooling Device

Hereinafter, an operation example of the board cooling device 100 according to this embodiment will be described with reference to FIG. 3. In the following, description will be given assuming that the one or more fans 8 (the pair of first fans 81 and the second fan 82), the third fan 83, the fourth fan 84, and the fifth fan 85 included in the board cooling device 100 are all driven.

With the third fan 83 being driven, the air blown out from the third fan 83 disperses water vapor generated by the processing associated with heat generation (in this case, fusing processing) performed by the process unit 5 (in this case, fuser 50). In addition, the air blown out from the third fan 83 also cools the process unit 5. Air containing the dispersed water vapor goes upward in the specific space Sp1.

With the pair of first fans 81 and the second fan 82 being driven, each of the pair of first fans 81 and the second fan 82 suctions the air containing water vapor from the specific space Sp1. At that time, the air containing water vapor is dispersed by the third fan 83 and goes upward in the specific space Sp1, which makes it possible for the pair of first fans 81 and the second fan 82 to efficiently suction the air containing water vapor from the specific space Sp1. The pair of first fans 81 blows out the suctioned air containing water vapor into the casing 7 via the first guideway 711 of the first air channel 71. In addition, the second fan 82 blows out the suctioned air containing water vapor into the casing 7 via the second guideway 712 of the first air channel 71. As a result, the air containing water vapor blown out from the pair of first fans 81 and the second fan 82 passes through the casing 7, thus cooling the board 6 disposed inside the casing 7.

In addition, with the fourth fan 84 being driven, the air blown out from the fourth fan 84 cools the specific component 611 mounted on the board 6. The air blown out from the fourth fan 84 cools the board 6 by merging with the air containing water vapor, which has been blown out from the pair of first fans 81 and the second fan 82.

The air that has passed through the casing 7 passes through the first passage 72a, the second passage 72b, and the third passage 72c of the second air channel 72 in sequence. At that time, the fifth fan 85 is driven to suction the air in the first passage 72a to be blown out to the third passage 72c, so that the air blown out from the casing 7 can easily reach the third passage 72c. Note that the air blown out from the fifth fan 85 has an air velocity that is too large as compared to the appropriate filtration air velocity of the filter 9, and is thus weakened by colliding with the inner wall in the second passage 72b, which is a restriction path.

The air that has passed through the second passage 72b passes through the first filter 91 in the third passage 72c. This removes foreign matter, mainly including VOCs, from the air. The air that has passed through the first filter 91 is further weakened in momentum by passing through the narrow passage 72d, which is a restriction path. As a result, the air velocity of the air that has passed through the narrow passage 72d approximately becomes an appropriate filtration air velocity of the second filter 92. The air that has passed through the narrow passage 72d then passes through the second filter 92, which removes foreign matter, mainly including UFPs, from the air. The air from which the foreign matter has been removed, and which has passed through the second filter 92, is then exhausted to the external space of the image forming apparatus 10 via the one or more ventilation holes 721.

As described above, in the board cooling device 100 according to this embodiment, the one or more fans 8 form an airflow from the specific space Sp1, in which the process unit 5 is disposed, into the casing 7. This allows the air containing water vapor generated by the processing associated with heat generation (in this case, fusing processing) of the process unit 5 (in this case, fuser 50) to be kept away from the specific space Sp1. Therefore, it is advantageous that water vapor is kept away from the specific space Sp1, which makes it easier to suppress the occurrence of failures caused by water vapor. In addition, the board cooling device 100 according to this embodiment forms an airflow, from the specific space Sp1 into the casing 7 in which the board 6 is housed, using the one or more fans 8. This makes it possible to cool the board 6 using the air containing water vapor suctioned from the specific space Sp1. In other words, the board cooling device 100 according to this embodiment has the advantage that the board 6 can be cooled while suppressing the occurrence of failures caused by the water vapor generated by the process unit 5.

### 3 Modified Examples

In the embodiment describe above, the board cooling device 100 includes the pair of first fans 81 and the second fan 82 as the one or more fans 8, but is not limited to this. For example, the board cooling device 100 may include only one of the first fan 81 and the second fan 82 as the one or more fans 8. In addition, the number of first fans 81 is not limited to two, but may be one, or three or more. Moreover, the number of second fans 82 is not limited to one, but may be two or more.

In the embodiment describe above, the one or more fans 8 are disposed at positions where air is suctioned from the specific space Sp1, but are not limited to this. For example, the one or more fans 8 may be disposed at the boundary between the casing 7 and the second air channel 72. In this case, the one or more fans 8 can form an airflow from the specific space Sp1 to the casing 7 by suctioning air in the specific space Sp1 and the casing 7. In addition, for example, the one or more fans 8 may be disposed at a position where air is blown out toward the specific space Sp1. In this case, the one or more fans 8 are capable of forming an airflow from the specific space Sp1 to the casing 7.

In the embodiment describe above, the filter 9 includes both the first filter 91 and the second filter 92, but is not limited to this. For example, the filter 9 may include one of the first filter 91 and the second filter 92.

In the embodiment describe above, the board cooling device 100 only needs to include the board 6, the casing 7, the one or more fans 8, and the first air channel 71. Therefore, the board cooling device 100 need not include at least one of the second air channel 72, the filter 9, the third fan 83, the fourth fan 84, or the fifth fan 85. If the board cooling device 100 does not include the second air channel 72, the casing 7 only needs to have an opening (not shown) that allows air guided into the casing 7 to escape to the external space of the image forming apparatus 10. Thus, air blown out to the casing 7 through the first air channel 71 is less likely to stay inside the casing 7, which makes it easier to efficiently cool the board 6.

### Notes of Disclosure

The outline of the disclosure extracted from the embodiment described above will be given below. Note that the configurations and processing functions described in the following notes can be discretionally selected and combined.

### Note 1

A board cooling device, including:

a board on which one or more components are mounted;

a casing that houses the board; and

one or more fans that form an airflow into the casing from a specific space in which a process unit that performs processing associated with heat generation in an apparatus main body of an image forming apparatus is disposed.

### Note 2

The board cooling device according to Note 1, in which

the one or more fans are disposed at a position where air is suctioned from the specific space, and

the board cooling device further includes a first air channel that guides air blown out from the one or more fans into the casing.

### Note 3

The board cooling device according to Note 2, further including:

a second air channel that includes, on a surface, one or more openings connected to an external space and guides air from the casing to the one or more openings; and

a filter that is disposed inside at least one of the casing, the first air channel, or the second air channel, and separates and collects airborne fine particles.

### Note 4

The board cooling device according to Note 3, in which

the filter is disposed in the second air channel, and

the second air channel includes one or more restriction paths that restrict a flow of air guided to the filter.

### Note 5

The board cooling device according to any one of Notes 2 to 4, in which

the one or more fans include a first fan and a second fan, and

the first air channel includes

a first guideway that guides air blown out from the first fan into the casing via a first opening provided in a surface of the casing, and

a second guideway that guides air blown out from the second fan into the casing via a second opening provided in another surface of the casing.

### Note 6

The board cooling device according to any one of Notes 1 to 5, further including

a third fan that blows out air toward the process unit.

### Note 7

The board cooling device according to any one of Notes 1 to 6, further including

a fourth fan that blows out air toward a specific component having a larger amount of heat generation than another component in the one or more components.

### Note 8

The board cooling device according to any one of Notes 1 to 7, in which

the process unit is a fusing device that performs fusing processing of heating a toner image on a sheet to fuse the toner image onto the sheet, and

the one or more components include a component for controlling a heater included in the fusing device.

### Note 9

An image forming apparatus, including:

an apparatus main body;

a process unit that is disposed in the apparatus main body and performs processing associated with heat generation; and

the board cooling device according to any one of Notes 1 to 8.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. A board cooling device, comprising:
a board on which one or more components are mounted;
a casing that houses the board; and
one or more fans that form an airflow into the casing from a specific space in which a process unit that performs processing associated with heat generation in an apparatus main body of an image forming apparatus is disposed.

2. The board cooling device according to claim 1, wherein
the one or more fans are disposed at a position where air is suctioned from the specific space, and
the board cooling device further comprises a first air channel that guides air blown out from the one or more fans into the casing.

3. The board cooling device according to claim 2, further comprising:
a second air channel that includes, on a surface, one or more openings connected to an external space and guides air from the casing to the one or more openings; and
a filter that is disposed inside at least one of the casing, the first air channel, or the second air channel, and separates and collects airborne fine particles.

4. The board cooling device according to claim 3, wherein
the filter is disposed in the second air channel, and
the second air channel includes one or more restriction paths that restrict a flow of air guided to the filter.

5. The board cooling device according to claim 2, wherein
the one or more fans include a first fan and a second fan, and
the first air channel includes
a first guideway that guides air blown out from the first fan into the casing via a first opening provided in a surface of the casing, and
a second guideway that guides air blown out from the second fan into the casing via a second opening provided in another surface of the casing.

6. The board cooling device according to claim 2, further comprising
a third fan that blows out air toward the process unit.

7. The board cooling device according to claim 2, further comprising
a fourth fan that blows out air toward a specific component having a larger amount of heat generation than another component in the one or more components.

8. The board cooling device according to claim 1, wherein
the process unit is a fusing device that performs fusing processing of heating a toner image on a sheet to fuse the toner image onto the sheet, and
the one or more components include a component for controlling a heater included in the fusing device.

9. An image forming apparatus, comprising:
an apparatus main body;
a process unit that is disposed in the apparatus main body and performs processing associated with heat generation; and
the board cooling device according to claim 1.
